(19) United States
(12) Patent Application Publication
(10) Pub. No.: US 2026/0316597 A1
(43) Pub. Date: Oct. 15, 2026

(54) MID-FRAME VEHICLE RAIL DESIGN FOR BATTERY PROTECTION

(71) Applicant: Rivian IP Holdings, LLC, Irvine, CA (US)

(72) Inventors: Jatin Sharma, Ann Arbor, MI (US); Andre Kenyonte Thompson, Novi, MI (US); Steve Siu, Irvine, CA (US); Christopher Peter Kohar, Irvine, CA (US); Abhishek Nayyar, Tustin, CA (US)

(21) Appl. No.: 19/176,972

(22) Filed: Apr. 11, 2025

(51) Int. Cl. B60L 50/64; B60K 1/04; B60L 50/60

(52) U.S. Cl. CPC B60L 50/64; B60K 1/04; B60L 50/66; B60K 2001/0438; B60L 2200/36

(57) ABSTRACT

An apparatus for providing structural support to a vehicle includes a frame member configured to be arranged on a lateral side of the vehicle and having a plurality of tubes, such as rectangular tubes. Each tube of the plurality of tubes has the same cross-sectional shape, and the plurality of tubes are laser seam welded together to form a stack. Bracketry and reinforcements may be laser welded to the stack. A vehicle includes a battery pack and a frame that includes a frame member on each lateral side, with each frame member having a bottom bracket affixed to the battery pack.

### INTRODUCTION

The present disclosure is directed to a mid-frame rail structure and, more particularly, a mid-frame rail formed using welded sections of tubing.

### SUMMARY

In some embodiments, the present disclosure is directed to an apparatus for a vehicle that includes a frame member. In some embodiments, the frame member is configured to deform and absorb energy during a side impact event to prevent damage to a battery pack of the vehicle. In some embodiments, the frame member is configured to be arranged on a lateral side of the vehicle and includes a plurality of rectangular tubes, or other suitable (e.g., stackable) shape. For example, each rectangular tube of the plurality of rectangular tubes has a same cross-sectional shape and are laser seam welded together to form a stack. In some embodiments, each of the plurality of rectangular tubes has a respective length. In some such embodiments, the stack includes a first array of the plurality of rectangular tubes that are longitudinally offset along their respective lengths from a second array of the plurality of rectangular tubes such that the first array and the second array longitudinally overlap each other except at opposite longitudinal ends of the stack. For example, the plurality of rectangular tubes may be bundled or stacked together, either as an array or as any other suitable configuration. In some embodiments, each respective length of each of the plurality of rectangular tubes is the same. In some embodiments, the plurality of rectangular tubes includes an even integer number (N) of rectangular tubes. In some such embodiments, the N rectangular tubes are arranged N/2 high and 2 across to form a N/2-by-2 array in cross section. For example, in some embodiments, the N rectangular tubes are arranged to form a first N/2-by-1 array and a second N/2-by-1 array, the first N/2-by-1 array is welded together, the second N/2-by-1 array is welded together, and the first and second N/2-by-1 arrays are welded and fastened to each other to form a N/2-by-2 array. In a further example, the plurality of rectangular tubes includes six rectangular tubes. In a further example, the six rectangular tubes have the same lengths, and the stack includes a first 3-by-1 stack of rectangular tubes longitudinally offset from a second 3-by-1 stack of rectangular tubes such that the first 3-by-1 stack and the second 3-by-1 stack longitudinally overlap each other except at opposite longitudinal ends of the stack. In some embodiments, each of the plurality of rectangular tubes is a rolled steel tube.

In some embodiments, the plurality of rectangular tubes includes a first tube and a second tube, where the first tube has a plurality of first holes along its length configured to accommodate a plurality of fasteners, and the second tube has a plurality of second holes along its length configured to accommodate the plurality of fasteners. The plurality of fasteners affix the first and second tubes together in the stack, for example. The first tube and the second tube may be located in a middle region of the stack.

In some embodiments, the frame member includes a first bracket configured to affix a first longitudinal end of the stack to a front frame of the vehicle, and a second bracket configured to affix a second longitudinal end of the stack, arranged opposite the first longitudinal end, to a rear frame of the vehicle. In some embodiments, the frame member includes a bottom bracket affixed to a bottom side of the stack that is configured to interface to a battery pack of the vehicle and to a body of the vehicle.

In some embodiments, the present disclosure is directed to a vehicle that includes a battery pack, and a frame comprising a frame member arranged on a lateral side of the battery pack and between a front wheel and a rear wheel. In some embodiments, the frame member includes a plurality of rectangular tubes where each rectangular tube has the same cross-sectional shape, the plurality of rectangular tubes are laser seam welded together to form a stack, and a bottom bracket affixed to a bottom side of the stack and coupled to the battery pack. In some embodiments, the bottom bracket is coupled to a body of the vehicle. In some embodiments, the plurality of rectangular tubes includes N tubes, N is an even integer, a first N/2-by-1 array is welded together, a second N/2-by-1 array is welded together, and the first and second N/2-by-1 arrays are welded and fastened to each other. In some embodiments, the frame includes a front frame and a rear frame, the frame member includes a first bracket configured to affix a first longitudinal end of the stack to the front frame, and the frame member includes a second bracket configured to affix a second longitudinal end of the stack, arranged opposite the first longitudinal end, to the rear frame.

In some embodiments, the present disclosure is directed to a method of making a frame rail for a vehicle. In some embodiments, the method includes arranging a plurality of rectangular tubes to form a stack, laser seam welding the plurality of rectangular tubes together in the stack, and affixing a bottom bracket to the stack. In some embodiments, the plurality of rectangular tubes each have a same cross-sectional shape, such as the same nominal cross-sectional dimensions. In some embodiments, the bottom bracket is configured to be coupled to a battery pack of the vehicle. In some embodiments, the plurality of rectangular tubes includes a first set and a second set of rectangular tubes. In some such embodiments, arranging the plurality of rectangular tubes includes arranging the first set in a first stack, arranging the second set in a second stack, and longitudinally offsetting the first stack and the second stack from each other to form the stack such that the first stack and the second stack longitudinally overlap each other except at opposite longitudinal ends of the stack. In some embodiments, the method includes fastening the first stack to the second stack at a plurality of locations arranged longitudinally along the first stack.

### BRIEF DESCRIPTION OF THE DRAWINGS

The present disclosure, in accordance with one or more various embodiments, is described in detail with reference to the following figures. The drawings are provided for purposes of illustration only and merely depict typical or example embodiments. These drawings are provided to facilitate an understanding of the concepts disclosed herein and shall not be considered limiting of the breadth, scope, or applicability of these concepts. It should be noted that for clarity and ease of illustration these drawings are not necessarily made to scale.

FIG. 1 shows a perspective view of an illustrative vehicle having a mid-frame, in accordance with some embodiments of the present disclosure;

FIG. 2 shows an underside view of the illustrative vehicle of FIG. 1 having a mid-frame, in accordance with some embodiments of the present disclosure;

FIG. 3 shows a perspective view of an illustrative vehicle frame, including a mid-frame, in accordance with some embodiments of the present disclosure;

FIG. 4 shows a perspective view of illustrative mid-frame rails, in accordance with some embodiments of the present disclosure;

FIG. 5 shows a front end view of one of the illustrative mid-frame rails of FIG. 4, in accordance with some embodiments of the present disclosure;

FIG. 6 shows a perspective exploded view of one of the illustrative mid-frame rails of FIGS. 4-5, in accordance with some embodiments of the present disclosure;

FIG. 7 is a flowchart of an illustrative process for making and installing a mid-frame rail, in accordance with some embodiments of the present disclosure; and

FIG. 8 is a flowchart of an illustrative process for making a mid-frame rail, in accordance with some embodiments of the present disclosure.

### DETAILED DESCRIPTION

In some embodiments, the present disclosure is directed to a mid-frame rail design. A vehicle, such as an electric delivery van, may include frame rails on each side of the battery pack, extending between the front and rear wheel wells. These frame rails may be substantially straight and may be bolted into the vehicle frame, interfacing to the front frame and rear frame. In some embodiments, a bracket affixed to the bottom of the mid-frame rail may interface to the battery pack and a body assembly. For example, because the mid-frame rail protects the battery pack, it may be designed to absorb energy from a side impact event. While frame members sometimes include extruded and machined parts, the present disclosure is directed to a tube-based designed using laser welding to reduce cost. In some embodiments, the mid-frame rail design of the present disclosure features a bundle of rectangular steel tubes, arranged in a 3×2 array, for example. To illustrate, because the tubes are each the same size (e.g., in cross-section), only a single material need be sourced, and the resulting component is more cost effective. Each tube is cut to length, laser cut (e.g., for holes, notches, or cutouts), and then laser seam welded together to form the stack. Brackets and other structural components may also be welded to the stack using a laser seam stepper (LSS).

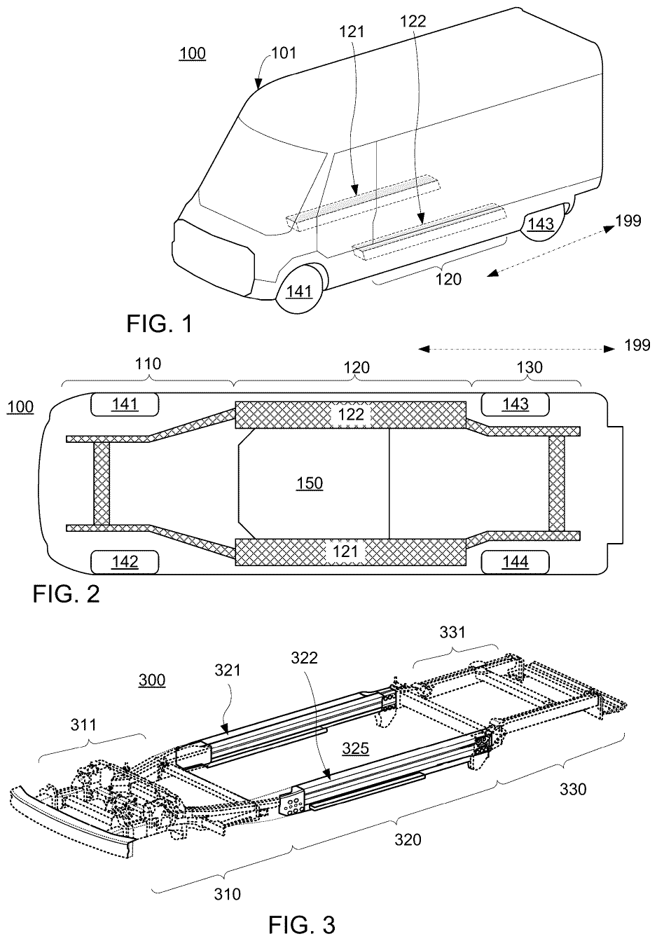

FIG. 1 shows a perspective view of illustrative vehicle 100 having mid-frame 120, in accordance with some embodiments of the present disclosure. FIG. 2 shows an underside view of illustrative vehicle 100 of FIG. 1 having mid-frame 120, in accordance with some embodiments of the present disclosure. As illustrated, vehicle 100 includes body 101 and four wheels (e.g., wheels 141, 142, 143, and 144). While vehicle 100 is illustrated as a cargo vehicle (e.g., a van), the present disclosure may be applied to any suitable vehicle, having any suitable type of powertrain (e.g., gas, diesel, electric, or a combination thereof such as a hybrid), having any suitable number of wheels, and being used for any suitable purpose (e.g., a passenger vehicle, a truck, a van, or any other suitable vehicle). As illustrated in FIG. 2, vehicle 100 includes front frame 110, mid-frame 120, and rear frame 130, each indicated by cross-hatching, and battery pack 150, which may include a battery, a plurality of batteries, electronics for managing battery power, any other suitable battery components, or any combination thereof. Battery pack 150 is arranged in a middle portion of the lower part of vehicle 100, within mid-frame 120. Mid-frame 120 includes rails 121 and 122, which are arranged on respective sides of battery pack 150, and may be configured to protect battery pack 150 from impact events. In some embodiments, mid-frame 120 extends between respective front and rear wheels of the vehicles. For example, rail 121 is arranged between wheels 142 and 144, and rail 122 is arranged between wheels 141 and 143. In some embodiments, rails 121 and 122 may be substantially straight, extending longitudinally (e.g., along axis 199 extending between the front and back of vehicle 100). In some embodiments, rails 121 and 122, or portions thereof, may be directed off of axis 199. In some embodiments, mid-frame 120 may include lateral members that extend between rails 121 and 122 (e.g., arranging in a lateral direction orthogonal to axis 199). In an illustrative example, body 101 and battery pack 150 may be secured to, and structurally supported by, rails 121 and 122.

FIG. 3 shows a perspective view of illustrative vehicle frame 300, including mid-frame 320, in accordance with some embodiments of the present disclosure. As illustrated, vehicle frame 300 includes front frame 310 (e.g., dotted lines), mid-frame 320, and rear frame 330 (e.g., dotted lines). In some embodiments, as illustrated, mid-frame 320 includes a pair of mid-frame rails (e.g., rail 321 and rail 322). In some embodiments, mid-frame 320 is fastened (e.g., bolted) to front frame 310 and rear frame 330. As illustrated, mid-frame 320 extends between front wheel wells (e.g., front wheel area 311 and rear wheel area 331). In some embodiments, mid-frame 320 surrounds area 325 in which a battery pack may be arranged. Rails 321 and 322 may include one or more brackets, reinforcements, affixments (e.g., welds, adhesives, fasteners, or a combination thereof), any other suitable components, or any combination thereof. In some embodiments, vehicle frame 300 or mid-frame 320 thereof may be included in a suitable vehicle such as vehicle 100 of FIGS. 1-2 (e.g., rails 321 and 322 may the same as or similar to rails 121 and 122). In an illustrative example, a body, battery pack, or both, may be secured to rails 121 and 122, which may provide structural support and protection.

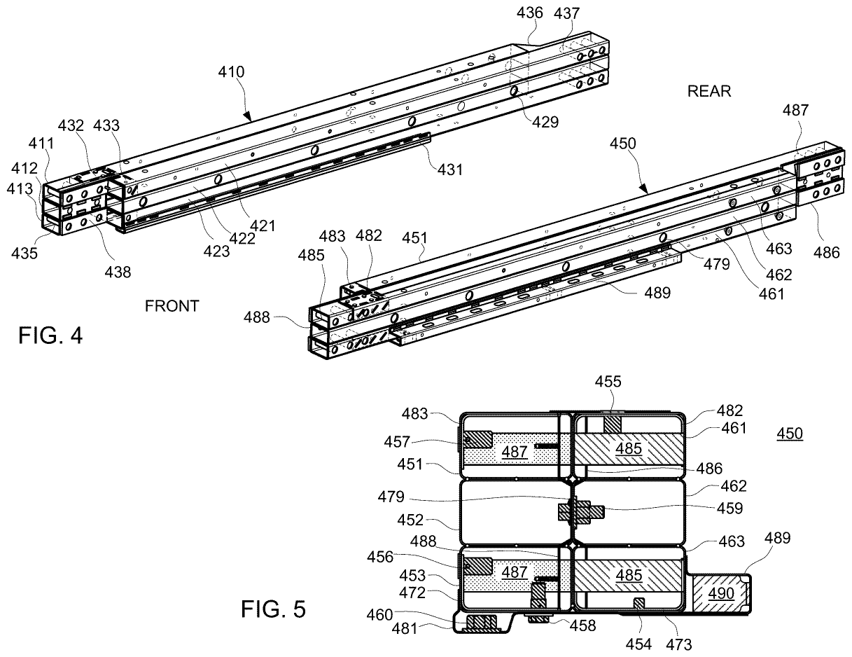

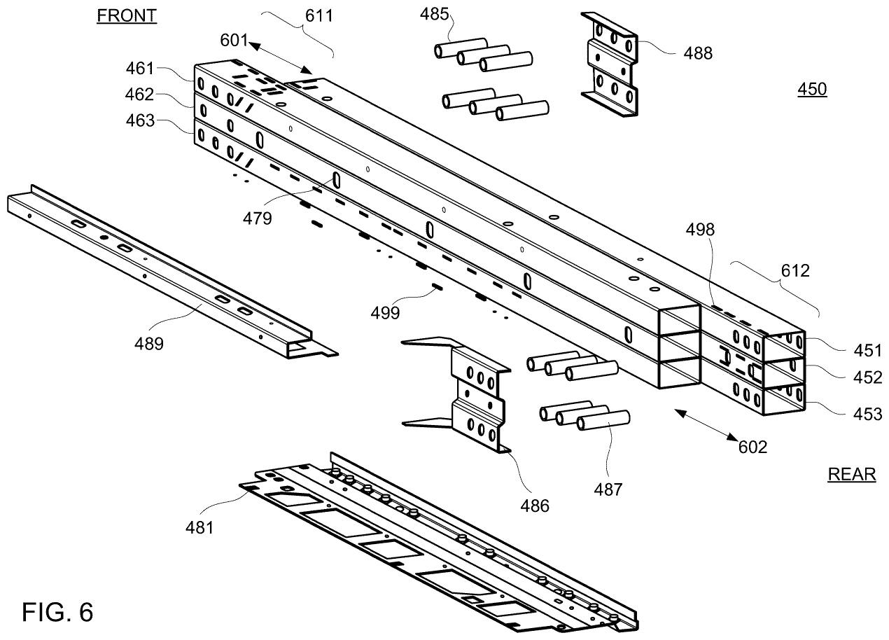

FIG. 4 shows a perspective view of illustrative mid-frame rails 410 and 450, in accordance with some embodiments of the present disclosure. The perspective view of FIG. 4 is taken from above the front driver's side of the mid-frame (e.g., similar to the orientation of vehicle 100 in FIG. 1). FIG. 5 shows a front end view of illustrative mid-frame rail 450 of FIG. 4, in accordance with some embodiments of the present disclosure. FIG. 6 shows an exploded perspective view of illustrative mid-frame rail 450 of FIG. 4 (as viewed from above the “REAR”), in accordance with some embodiments of the present disclosure. In some embodiments, a frame member of the present disclosure, such as mid-frame rails 410 and 450, may be configured to deform and absorb energy during a side impact event to prevent damage to a battery pack (e.g., battery pack 150 of vehicle 100 of FIGS. 1-2).

As illustrated, mid-frame rail 410 includes tubes 411, 412, 413, 421, 422, and 423, which may each be a rectangular tube with rounded corners having the same thickness and cross-sectional dimensions. While tubes 411, 412, 413 421, 422, and 423 are illustrated as rectangular tubes with rounded corners, the tubes included in mid-frame rail 410 may have any suitable cross-sectional shape (e.g., triangular, hexagonal) or any combination of suitable cross-sectional shapes, (e.g., that can be welded together and stacked side-by-side or otherwise adjacent, as discussed herein). Mid-frame rail 410 also includes brackets 436 and 438, reinforcements 432 and 433, inner bracket 431, an outer bracket (not visible in FIG. 4, but similar to outer bracket 489 of mid-frame rail 450), sleeves 435 and 437 (e.g., six of each, as illustrated), and fasteners (not shown but similar to those illustrated for mid-frame rail 450 in FIG. 5). In some embodiments, tubes 411, 412, 413, 421, 422, and 423 are welded and fastened together to form a stack (e.g., as a 3-by-2 array). In some embodiments, tubes 411, 412, and 413 are welded together to form a first stack (e.g., as a 3-by-1 array), and tubes 421, 422, and 423 are welded together to form a second stack (e.g., as another 3-by-1 array). The first and second stacks may then be welded and fastened together to form the stack (e.g., the 3×2 array). In forming a stack of tubes, the constituent tubes may be arranged side by side, on top of each other, or both such that their lengths coincide or at least partially overlap. For example, tubes 411, 412, and 413 may all have the same length and may be arranged as a 3×1 array, stacked with their lengths coinciding longitudinally. Tubes 421, 422, and 423 may all have the same length (e.g., which may be, but need not be the same as tubes 411, 412, and 413) and may also be arranged as another 3×1 array, stacked with their lengths coinciding longitudinally. The two 3-by-1 stacks may then be stacked side by side, overlapping along their respective lengths except at the ends (e.g., where brackets 436 and 438 are arranged) such that the two stacks are longitudinally offset. For example, the longitudinal offset may be equal to or greater than a length of brackets 436 and 438. As illustrated in FIG. 6, offset 601 is a first distance at the front of the stack (e.g., first longitudinal end 611 of the stack) and offset 602 is a second distance at the rear of the stack (e.g., second longitudinal end 612 opposite to first longitudinal end 611). In some embodiments, offsets 601 and 602 may be equal. In some embodiments, offset 601 is configured to accommodate bracket 488, and offset 602 is configured to accommodate bracket 486.

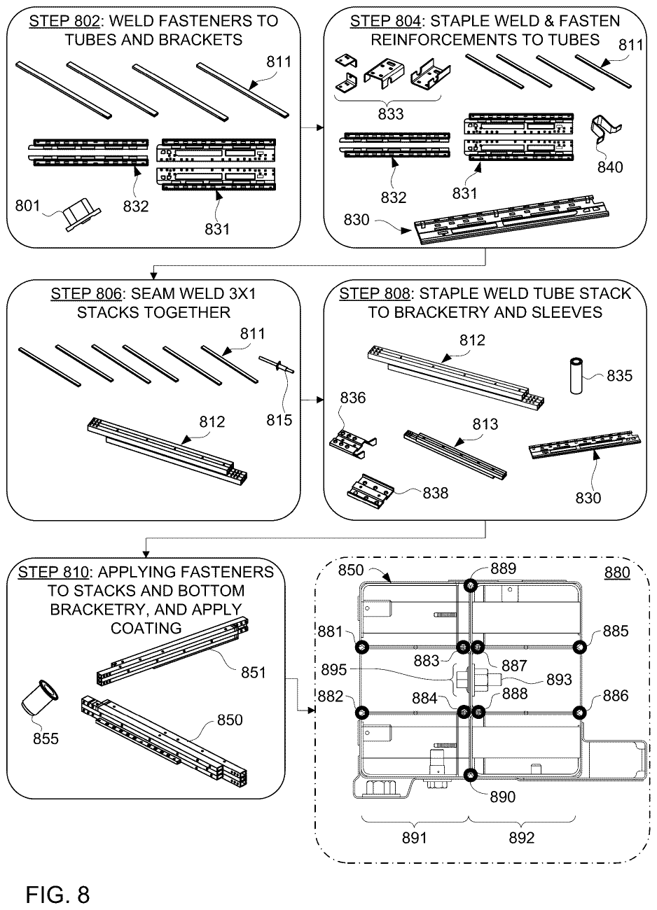

As illustrated, mid-frame rail 450 includes tubes 451, 452, 453, 461, 462, and 463, which may each be a rectangular tube with rounded corners having the same thickness and cross-sectional dimensions. Mid-frame rail 450 also includes brackets 486 and 488, reinforcements 482 and 483, inner bracket 481, outer bracket 489, sleeves 485 and 487 (e.g., six of each, as illustrated), fasteners 459 and 460, and fasteners 454, 455, 456, and 457 (as illustrated in FIG. 5). Reinforcement 490 provides structural support to outer bracket 489. Collectively, inner bracket 481 and outer bracket 489 may be referred to as a bottom bracket (e.g., and may be joined or formed together as a single bracket, as illustrated in FIG. 8). For example, the bottom bracket may be configured to be affixed or otherwise coupled to a bottom side of the stack and coupled to a battery pack (e.g., inner bracket 481 is configured to interface with the battery pack), and may be configured to be affixed or otherwise coupled to a body of the vehicle (e.g., outer bracket 489 is configured to interface with the body). In some embodiments, tubes 451, 452, 453, 461, 462, and 463 are welded and fastened together to form another stack (e.g., as a 3×2 array). In some embodiments, tubes 451, 452, and 453 are welded together to form a first stack (e.g., as a 3×1 array), and tubes 461, 462, and 463 are welded together to form a second stack (e.g., as another 3×1 array). The first and second stacks may then be welded and fastened together to form the stack (e.g., the 3×2 array). In an illustrative example, tubes 451, 452, and 453 may all have the same length and may be arranged as a 3×1 array, stacked with their lengths coinciding longitudinally. Tubes 461, 462, and 463 may all have the same length (e.g., which may be, but need not be the same as tubes 451, 452, and 453) and may also be arranged as another 3×1 array, stacked with their lengths coinciding longitudinally. The two 3×1 stacks may then be stacked side by side, overlapping along their respective lengths except at the ends (e.g., where brackets 486 and 488 are arranged) such that the two stacks are longitudinally offset. For example, the longitudinal offset may be equal to or greater than a length of brackets 486 and 488. In a further example, both mid-frame rails 410 and 450 may be substantially identical and thus may have the same dimensions except they are reflected about a longitudinal axis (e.g., mid-frame rails 410 and 450 may have mirrored designs about the center longitudinal axis of the intended vehicle or frame thereof).

In some embodiments, tubes 411, 412, 413, 421, 422, 423, 451, 452, 453, 461, 462, and 463 all have the same cross-sectional shape and wall thickness. For example, each of tubes 411, 412, 413, 421, 422, 423, 451, 452, 453, 461, 462, and 463 may be cut to length from a single type and dimension of rolled tube (e.g., only a single tube material need be sourced). Each of tubes 411, 412, 413, 421, 422, 423, 451, 452, 453, 461, 462, and 463 has a corresponding length, which all may be, but need not be, the same.

As illustrated in FIG. 5, which shows mid-frame rail 450 as viewed from the front (e.g., as indicated by “FRONT” in FIG. 4), mid-frame rail 450 includes a 3×2 stack of rectangular tubes with sleeves, bracketry, and fasteners. In some embodiments, inner bracket 481 and outer bracket 489 are separate brackets, each welded, fastened, or both, to the stack. In some embodiments, inner bracket 481 and outer bracket 489 are joined (e.g., to form a bottom bracket) prior to affixing to the stack. For example, inner bracket 481 and outer bracket 489 may be LSS welded together and then LSS welded, fastened, or both, to the stack. For example, as illustrated in FIG. 6, welds 498 and 499 may be LSS welds, or any other suitable type of weld. In a further example, welds 498 may join bracket 486 and bracket 488 to the tubes (e.g., and may include welds underneath the stack). Welds 499 may join outer bracket 489 to the stack (e.g., and inner bracket 481 using suitable weld locations). In some embodiments, inner bracket 481 and outer bracket 489 need not be separate components (e.g., are a single component). For example, a frame rail may include a bracket that includes suitable features of both inner bracket 481 and outer bracket 489 but is a single component (e.g., a rolled component formed from plate or sheet metal).

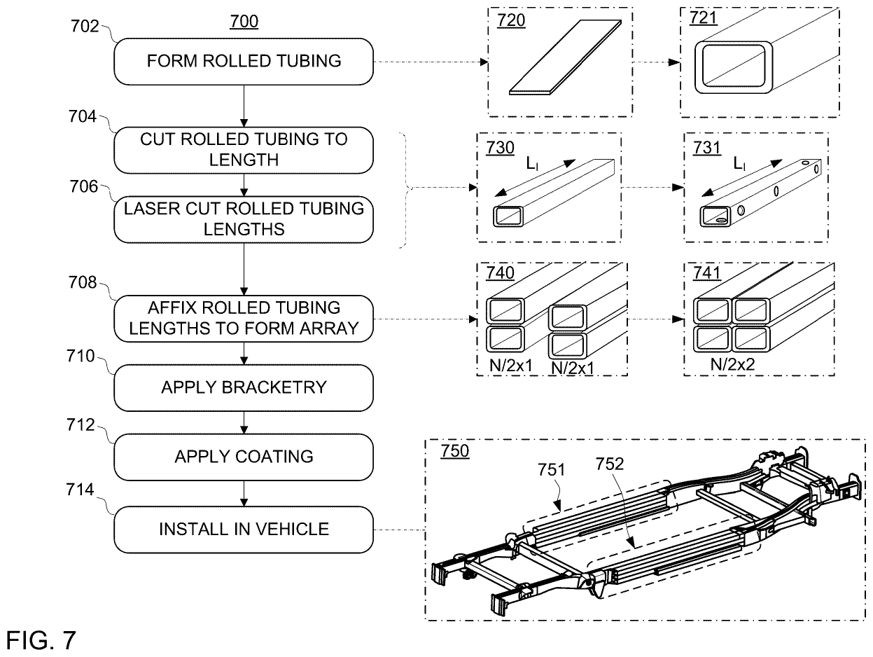

FIG. 7 is a flowchart of illustrative process 700 for making and installing a mid-frame rail, in accordance with some embodiments of the present disclosure.

Step 702 includes forming rolled tubing. In some embodiments, step 702 includes receiving a billet or other starting material. The starting material may already be a suitable thickness (e.g., nominally the intended thickness of the resulting rolled tubing), or may be processed to a suitable thickness. For example, the starting material may be a coiled roll of metal sheet, as illustrated in panel 720 (e.g., after the sheet is flattened). The starting material may then be rolled, using a series of suitably shaped rollers to roll the sheeting laterally into the intended cross-section, as illustrated in panel 721. The rolled tubing may then be cut to a rough length for transport or handling. In an illustrative example, the starting material may be steel (e.g., dual phase steel such as DP980 or DP1000), and each of the plurality of tubes of the stack may be a rolled steel tube (e.g., the plurality of rectangular tubes may include six rectangular tubes). In a further example, the resulting rolled tubing may have any suitable thickness (e.g., 1 mm, or any other suitable thickness).

Step 704 includes cutting the rolled tubing to length. In some embodiments, the rolled tubing formed at step 702 may be more precisely cut at step 704 to a desired length Lᵢ for the i^{th} tube (e.g., the length intended for each tube in the final mid-frame rail), as illustrated in panel 730. In an illustrative example, the length Lᵢ for each tube may be any suitable length (e.g., 2-3 meters or any other suitable length). Step 704 includes applying any suitable cutting technique to form lengths of rolled tubing for further processing into a mid-frame rail. For example, step 704 may include applying a circular cutoff wheel, a band saw, a laser cutter, a plasma cutter, or any other suitable cutting technique and equipment. In some embodiments, step 704 may be combined with step 702, or otherwise omitted (e.g., if the rolled tubing is formed in suitable lengths at step 702). In an illustrative example, the tubing may include steel tubes (e.g., dual phase steel such as DP980-590Y) having a suitable wall thickness (e.g., 1 mm, less than 1 mm, or greater than 1 mm). In some embodiments, the respective lengths Lᵢ of all the plurality of tubes are the same. In some embodiments, the respective lengths Lᵢ of subset of the plurality of tubes are the same, and another subset of tubes may have a different length.

Step 706 includes laser cutting the rolled tubing lengths. Step 706 may include cutting holes, recesses, notches, or other features in the rolled tubing lengths, as illustrated in panel 731. For example, in some embodiments, step 706 includes laser cutting holes intended for fasteners, sleeves, or other components to pass through. In some embodiments, step 706 includes cutting the rolled tubing lengths to reduce mass, balance mass, or otherwise remove material to achieve a target property of the rolled tubing lengths. In some embodiments, step 706 may be omitted (e.g., any holes that are intended may be formed using machining, punching, drilling, or other technique).

Step 708 includes affixing the rolled tubing lengths to form an array. In some embodiments, each mid-frame rail includes N rolled tubing lengths, which may be, but need not be, the same length as each other. For example, in some embodiments, step 708 includes affixing N rolled tubing lengths together to form an array, where N is a suitable positive integer. In some embodiments, N is an even integer. For example, N may be four, six, eight, or any other suitable number. In some embodiments, step 708 includes welding the lengths together to form the array. For example, step 708 may include laser seam welding the lengths together along the full lengths of the tubing that axially overlap. In a further example, step 708 may include laser seam welding the lengths together along at least some of the full lengths of the tubing that axially overlap. In some embodiments, step 708 includes fastening the lengths together to form the array. In some embodiments, step 708 includes welding and fastening the lengths together to form the array. For example, the stack may include N rectangular tubes that are arranged to form a first N/2-by-1 array and a second N/2-by-1 array, as illustrated in panel 740. The first N/2-by-1 array may be welded together (e.g., as a first stack), and the second N/2-by-1 array may be welded together (e.g., to form a second stack). The first and second N/2-by-1 arrays may then be welded and fastened to each other to form a N/2-by-2 array, as illustrated in panel 741. In some embodiments, a stack may include N rectangular tubes that are arranged N/2 high and 2 across to form a N/2-by-2 array in cross section, as illustrated in panel 741 (e.g., wherein N is equal to four), and may be welded in any suitable order.

Step 710 includes applying bracketry to the array. In some embodiments, step 710 includes fastening one or more brackets to the array, using any suitable fastener (e.g., bolts, rivets, or other suitable fasteners). In some embodiments, step 710 includes welding one or more brackets to the array, using any suitable technique (e.g., laser seam welding, laser seam stitch welding, staple welding, or any suitable non-laser technique). Bracketry may include, for example, plates, formed parts, sleeves, any other suitable components, or any combination thereof, for interfacing to other structures of the vehicle or otherwise affecting the interfaces (e.g., providing strength to the interfaces). For example, the bracketry may be configured to interface to other frame components or otherwise components of the vehicle when the mid-frame rail is installed at step 714.

Step 712 includes applying a suitable coating to a component or surface regions thereof. In some embodiments, a coating is applied to metal surfaces to protect against corrosion, chemically treat the surface, any other suitable purpose, or any combination thereof. For example, the coating may include an electrochemically applied coating, powder coating, ceramic coating, paint, any other suitable coating type, or any combination thereof. In some embodiments, step 712 includes preparing the surface for coating (e.g., sanding, grinding, mechanically cleaning, electrochemically cleaning, chemically cleaning), masking the surface, post-processing the surface, any other suitable process, or any combination thereof. Although illustrated as occurring after step 710, step 712 may be performed between any suitable steps of process 700, concurrent with any steps of process 700, or be omitted either partially or in totality.

Step 714 includes installing the mid-frame rail in a vehicle. In some embodiments, step 714 may be repeated for any suitable number of mid-frame rails (e.g., two, as illustrated in FIGS. 1-3). In some embodiments, step 714 includes affixing the mid-frame rail to a front frame, a rear frame, a battery pack, a body structure, any other suitable structure, or any combination thereof. In some embodiments, step 714 includes bolting the mid-frame rails to other structures. For example, step 714 may include bolting the mid-frame rail to a front frame and to a rear frame. Panel 750 illustrates a frame having mid-frame rails 751 and 752 installed.

In an illustrative example, the present disclosure may be directed to a steel mid rail assembly of a frame, using steel tubes that are laser welded together to form an energy absorbing structure (e.g., during side impacts). Process 700 may be applied to make the frame and may allow a reduced cost of manufacturing because little to no machining or friction stir welding is required, nor is extrusion needed to form the rails. For example, because steps 706, 708, and 710 may utilize laser seam welding, LSS (Laser Seam Stepper) welding, or both, for joining components, process 700 may allow for a relatively reduced heat affected zone.

In an illustrative example of process 700, referencing mid-frame rails 410 and 450 of FIGS. 4-6, step 704 may include cutting tubes 411, 412, 413, 421, 422, 423, 451, 452, 453, 461, 462, and 463 to respective lengths, which may the same length or different lengths. Step 706 may include laser cutting holes (e.g., including holes 429 and holes 479) and other features in tubes 411, 412, 413, 421, 422, 423, 451, 452, 453, 461, 462, and 463 based on a predetermined pattern. Step 708 may include laser seam welding tubes 411, 412, and 413 together along their at least some of their overlapping lengths (e.g., the entire overlapping length); laser seam welding tubes 421, 422, and 423 together along their at least some of their overlapping lengths (e.g., the entire overlapping length); laser seam welding tubes 451, 452, and 453 together along their at least some of their overlapping lengths (e.g., the entire overlapping length); and laser seam welding tubes 461, 462, and 463 together along their at least some of their overlapping lengths (e.g., wherein “N” of panel 740 is equal to six). Step 708 may also include laser seam welding the stack of tubes 411-413 to the stack of tubes 421-423 at a top and bottom (e.g., along the entire overlapping length or a portion thereof), and fastening these stacks together at the interface of tube 412 and 422 along their lengths (e.g., using fasteners inserted in holes 429). Step 708 may also include laser seam welding the stack of tubes 451-453 to the stack of tubes 461-463 at a top and bottom, and fastening these stacks together at the interface of tube 452 and 462 along their lengths (e.g., using fasteners 459 inserted laterally in holes 479, which may extend laterally through the entire stack). For example, holes 479 may extend fully through both tube 452 and tube 462 (e.g., both inner and outer side walls) such that fasteners 459 may be installed. In some embodiments, holes 479 on inner side walls may be of a first size to fit a first portion (e.g., a threaded portion) of fastener 459 for fastening inner side walls together, while holes 479 at outer side walls may be of a second size larger than the first size to allow a second portion (e.g., a bolt head) to of fastener 459 or fastening tool to pass through.

In a further illustrative example of process 700, referencing mid-frame rails 410 and 450 of FIGS. 4-6, step 710 may include applying (e.g., LSS welding, affixing, or both) sleeves 435 and 437, reinforcements 432 and 433, brackets 436 and 438, inner bracket 431, and an outer bracket to the stack of tubes 411, 412, 413, 421, 422, and 423. For example, sleeves 435 may be applied to each of tubes 411, 412, and 413 (e.g., two sleeves per tube, spanning the lateral width of the tubes) to reinforce the interface to bracket 438. Further, sleeves 437 may be applied to each of tubes 421, 422, and 423 (e.g., two sleeves per tube, spanning the lateral width of the tubes) to reinforce the interface to bracket 436. Reinforcement 432 may be applied to the interior of tube 411 using LSS welding and one or more fasteners, and reinforcement 433 may be applied to the interior of tube 421 using LSS welding and one or more fasteners. Bracket 436 may be LSS welded to tubes 411, 412, 413, 421, 422, and 423 at the rear of the stack (e.g., to be interfaced to a rear frame of a vehicle). Bracket 438 may be LSS welded to tubes 411, 412, and 413 at the front of the stack (e.g., to be interfaced to a front frame of a vehicle). Inner bracket 431 may be LSS welded and fastened (using one or more fasteners) to the stack at the bottom of the stack on a laterally inner side (e.g., toward a battery pack), and an outer bracket may be LSS welded and fastened (using one or more fasteners) to the stack at the bottom of the stack on a laterally outer side (e.g., toward the vehicle exterior). Step 710 may also include applying (e.g., LSS welding, affixing, or both) sleeves 485 and 487, reinforcements 482 and 483, brackets 486 and 488, inner bracket 481, and outer bracket 489 to the stack of tubes 451, 452, 453, 461, 462, and 463. For example, sleeves 487 may be applied to each of tubes 451, 452, and 453 (e.g., two sleeves per tube, spanning the lateral width of the tubes) to reinforce the interface to bracket 486. Further, sleeves 485 may be applied to each of tubes 461, 462, and 463 (e.g., two sleeves per tube, spanning the lateral width of the tubes) to reinforce the interface to bracket 488.

Reinforcement 472 may be applied to the interior of tube 453 using LSS welding and one or more fasteners 456 (e.g., shown in FIG. 5), reinforcement 473 may be applied to the interior of tube 463 using LSS welding and one or more fasteners 454 (e.g., shown in FIG. 5), reinforcement 482 may be applied to the interior of tube 461 using LSS welding and one or more fasteners 455 (e.g., shown in FIG. 5), and reinforcement 483 may be applied to the interior of tube 451 using LSS welding and one or more fasteners 457 (e.g., shown in FIG. 5). Bracket 486 may be LSS welded to tubes 451, 452, 453, 461, 462, and 463 at the rear of the stack (e.g., to be interfaced to a rear frame of a vehicle). Bracket 488 may be LSS welded to tubes 461, 462, and 463 at the front of the stack (e.g., to be interfaced to a front frame of a vehicle). Inner bracket 481 may be LSS welded and fastened (e.g., using one or more fasteners 458 of FIG. 5) to the stack at the bottom of the stack on a laterally inner side (e.g., toward a battery pack), and outer bracket 489 may be LSS welded and fastened (e.g., using one or more fasteners 454 of FIG. 5) to the stack at the bottom of the stack on a laterally outer side (e.g., toward the vehicle exterior).

FIG. 8 is a flowchart of illustrative process 800 for making a mid-frame rail, in accordance with some embodiments of the present disclosure.

Step 802 includes welding fasteners to tubes (e.g., rolled rectangular tubing lengths) and brackets. For example, in some embodiments, step 802 includes installing captive or non-captive nuts (e.g., nuts 801) in suitable holes of tubes 811 (e.g., six in total for each frame rail) or bracketry (e.g., outer brackets 832 and inner brackets 831) such that threaded fasteners may be engaged with the nuts to secure interfaces of components. One of outer brackets 832 and one of inner brackets 831 may be included in each of mid-frame rails 850 and 851.

Step 804 includes staple welding, and optionally fastening, tubes 811 to inner reinforcements 833, and outer brackets 832 and inner brackets 831 together to form bottom brackets 830. In some embodiments, step 804 includes applying a LSS welder. Step 804 may include applying any suitable welding technique to affix the inner reinforcements to the tubes, and the first and second brackets. In some embodiments, a bottom bracket may be a single piece (e.g., there need not be separate inner and outer brackets), and step 804 need not be applied to the bottom bracket. Step 804 may include stable welding, fastening, or both, reinforcements 840 (e.g., a total of three per mid-frame rail) to each of outer brackets 832 (or bottom brackets 830 after joining of inner and outer brackets). For example, reinforcements 840 may be the same as reinforcements 490 of FIG. 5.

Step 806 includes seam welding a first N/2-by-1 stack to a second N/2-by-1 stack to form a N/2-by-2 array (e.g., of N tubes total). As illustrated, N is equal to three. As illustrated in panel 880, step 806 may include applying welds 881-890 to form stack 812 from tubes 811. In some embodiments, for example, fasteners 815 may include rivets and may be applied to help in attaching brackets 833 to the stack (e.g., after brackets 833 are LSS welded to tubes 811).

Step 808 includes welding (e.g., staple welding) the assembly of step 806 to the bracketry and sleeves. For example, step 808 may include welding (e.g., staple welding) one each of brackets 837 and 836 to the front and rear, respectively, of stacks 812 and 813. Step 808 may include arranging sleeves 835 (e.g., six per stack) in corresponding holes in each of stacks 812 and 813 (e.g., at each end) and welding (e.g., staple welding) sleeves 835 to stacks 813 and 813. Step 808 may also include arranging each of bottom brackets 830 (e.g., formed from outer brackets 832 and inner brackets 831) at a bottom side of each of stacks 812 and 813 and welding (e.g., staple welding) bottom brackets 830 to stacks 812 and 813. In some embodiments, each of brackets 838 is a first bracket configured to affix a first longitudinal end of each of stacks 812 and 813 to a front frame of the vehicle. In some embodiments, each of brackets 836 is a second bracket configured to affix a second longitudinal end of each of stacks 812 and 813, arranged opposite the first longitudinal end, to a rear frame of the vehicle. Similarly, referencing FIGS. 4-6, brackets 438 and 488 may be first brackets, and brackets 436 and 486 may be second brackets. Refencing FIG. 6, brackets 488 and 486 may be installed at opposite longitudinal ends of the stack, illustrated by first and second longitudinal ends 611 and 612.

Step 810 includes applying fasteners to the stack (e.g., or the first and second stacks thereof), bracketry, or both, and applying a suitable coating. In some embodiments, step 810 includes finishing such as, for example, applying fasteners 855, coating, and labeling mid-frame rails 850 and 851, along with any other suitable steps in creating mid-frame rails 850 and 851. In some embodiments, fasteners 855 may include female threads (e.g., to which male threads may be engaged from the battery pack or the body system).

Panel 880 illustrates mid-frame rail 850, which may be identical to mid-frame rail 450 of FIGS. 4-6. Mid-frame rail 850 includes welds 881, 882, 883, 884, 885, 886, 887, 888, 889, and 890, which may all include laser seam welds. For example, in some embodiments, stack 891 (e.g., the left three tubes stacked 3×1) may be affixed using seam welds (e.g., welds 881-884), and stack 892 (e.g., the right three tubes stacked 3×1) may be affixed using seam welds (e.g., welds 885-888). Stacks 891 and 892 may then be affixed to each other using seam welds (e.g., welds 889 and 890), at step 806. Because, once arranged as a 3×2 array, the seam along the middle of stacks 891 and 892 is not accessible or otherwise exhibits less accessibility, fasteners 893 (e.g., similar to fasteners 459 of FIG. 5) may be applied to join middle interface 895 at step 806, step 810, any other suitable step, or any combination thereof, of process 700 or process 800.

In an illustrative example, mid-frame rails 850 and 851 may be configured to provide structural support to a vehicle. Mid-frame rails 850 and 851 may be arranged and installed as frame members on opposite lateral sides the of the vehicle (e.g., at step 714 of process 700). In some embodiments, each of mid-frame rails 850 and 851 may include a plurality of rectangular tubes (e.g., tubes 811) that all have the same cross-sectional shape and are laser seam welded together at step 806 to form the respective stacks.

In a further illustrative example, each of a plurality of rectangular tubes (e.g., tubes 811) has a respective length Lᵢ, and stack 812 includes a first array of a subset of tubes 811 longitudinally offset along their respective lengths from a second array of another subset of tubes 811 such that the first array and the second array longitudinally overlap each other except at opposite longitudinal ends of the stack, as illustrated by stack 812 in panel 806. For example, each of tubes 811 may have the same length, and stack 812 may include a first 3-by-1 stack of rectangular tubes longitudinally offset from a second 3-by-1 stack of rectangular tubes such that the first 3-by-1 stack and the second 3-by-1 stack longitudinally overlap each other except at opposite longitudinal ends of the stack, as illustrated in panel 806. Referencing FIG. 6, for example, tubes 451, 452, and 453 may form a first stack, and tubes 461, 462, and 463 may form a second stack. The first and second stacks may be affixed together to form a stack, longitudinally offset to allow brackets 486 and 488 to be installed (e.g., the offset may approximately equal the length of brackets 486 and 488 in the longitudinal direction). As illustrated, offset 601 is achieved at the front of the stack (e.g., first longitudinal end 611), and offset 602 is achieved at the rear of the stack (e.g., second longitudinal end 612). For example, offsets 601 and 602 are equal if tubes 451, 452, 453, 461, 462, and 463 are the same length. Offsets 601 and 602 form respective recesses in the stack at the respective longitudinal ends, to allow interfacing frame members of the front and rear frame to engage with brackets 488 and 486 (e.g., with longitudinal overlap to strengthen the interface).

In a further illustrative example, the plurality of rectangular tubes (e.g., tubes 811) may include a first tube and a second tube. For example, referencing FIGS. 4-6, the first tube may be tube 452 and the second tube may be tube 462. The first tube (e.g., tube 452) includes a plurality of first through holes (e.g., corresponding to holes 479) along its length configured to accommodate a plurality of fasteners (e.g., fasteners 459). The holes may extend through both sides of the tube such that a fastener (or portion thereof) may be passed through the holes. The second tube (e.g., tube 462) includes a plurality of second through holes (e.g., corresponding to holes 479) along its length configured to accommodate the plurality of fasteners (e.g., fasteners 459). The plurality of fasteners (e.g., fasteners 459) affix the first and second tubes (e.g., tubes 452 and 462) together in the stack, as illustrated at step 810 of process 800. In some embodiments, step 810 includes fastening the first stack to the second stack at a plurality of locations arranged longitudinally along the first stack.

In a further illustrative example, process 800 may include arranging a plurality of rectangular tubes having the same cross-sectional shape (e.g., tubes 811) for form a stack (e.g., each of stacks 812 and 813), laser seam welding the plurality of rectangular tubes (e.g., tubes 811) together in the stack (e.g., each of stacks 812 and 813), and affixing each of bottom brackets 830 to each of stacks 812 and 813. Each of bottom brackets 830 is configured to be coupled to a battery pack of the vehicle (e.g., on opposite lateral sides of the battery pack).

In a further illustrative example, tubes 811 may include a first set and a second set of rectangular tubes, and step 806 may include arranging the first set in a first stack, arranging the second set in a second stack, and longitudinally offsetting the first stack and the second stack from each other. For example, referencing FIG. 6, step 806 may include forming a stack such that the first stack (e.g., tubes 451, 452, and 453) and the second stack (e.g., tubes 461, 462, and 463) longitudinally overlap each other along their lengths except at opposite longitudinal ends of the stack (e.g., first and second longitudinal ends 611 and 612), illustrated by offsets 601 and 602.

The foregoing is merely illustrative of the principles of this disclosure and various modifications may be made by those skilled in the art without departing from the scope of this disclosure. The above-described embodiments are presented for purposes of illustration and not of limitation. The present disclosure also can take many forms other than those explicitly described herein. Accordingly, it is emphasized that this disclosure is not limited to the explicitly disclosed methods, systems, and apparatuses, but is intended to include variations to and modifications thereof, which are within the spirit of the following claims.

What is claimed is:

1. An apparatus for a vehicle, comprising:
a frame member configured to be arranged on a lateral side of the vehicle, wherein:
the frame member comprises a plurality of rectangular tubes;
each rectangular tube of the plurality of rectangular tubes has a same cross-sectional shape; and
the plurality of rectangular tubes are laser seam welded together to form a stack.

2. The apparatus of claim 1, wherein each of the plurality of rectangular tubes comprises a respective length, and wherein the stack comprises a first array of the plurality of rectangular tubes that are longitudinally offset along their respective lengths from a second array of the plurality of rectangular tubes such that the first array and the second array longitudinally overlap each other except at opposite longitudinal ends of the stack.

3. The apparatus of claim 2, wherein each respective length of each of the plurality of rectangular tubes is the same.

4. The apparatus of claim 1, wherein the plurality of rectangular tubes comprises N rectangular tubes, wherein N is an even integer.

5. The apparatus of claim 4, wherein the N rectangular tubes are arranged N/2 high and 2 across to form a N/2-by-2 array in cross section.

6. The apparatus of claim 4, wherein:
the N rectangular tubes are arranged to form a first N/2-by-1 array and a second N/2-by-1 array;
the first N/2-by-1 array is welded together;
the second N/2-by-1 array is welded together; and
the first and second N/2-by-1 arrays are welded and fastened to each other to form a N/2-by-2 array.

7. The apparatus of claim 1, wherein the plurality of rectangular tubes comprises six rectangular tubes.

8. The apparatus of claim 7, wherein the six rectangular tubes comprise the same lengths, and wherein the stack comprises a first 3-by-1 stack of rectangular tubes longitudinally offset from a second 3-by-1 stack of rectangular tubes such that the first 3-by-1 stack and the second 3-by-1 stack longitudinally overlap each other except at opposite longitudinal ends of the stack.

9. The apparatus of claim 1, wherein:
the plurality of rectangular tubes comprises a first tube and a second tube;
the first tube comprises a first length and a plurality of first holes along the first length configured to accommodate a plurality of fasteners;
the second tube comprises a second length and a plurality of second holes along the second length configured to accommodate the plurality of fasteners; and
the plurality of fasteners affix the first and second tubes together in the stack.

10. The apparatus of claim 1, further comprising:
a first bracket configured to affix a first longitudinal end of the stack to a front frame of the vehicle; and
a second bracket configured to affix a second longitudinal end of the stack, arranged opposite the first longitudinal end, to a rear frame of the vehicle.

11. The apparatus of claim 1, further comprising a bottom bracket affixed to a bottom side of the stack and configured to interface to a battery pack of the vehicle and to a body of the vehicle.

12. The apparatus of claim 1, wherein each of the plurality of rectangular tubes is a rolled steel tube.

13. The apparatus of claim 1, wherein the frame member is configured to deform and absorb energy during a side impact event to prevent damage to a battery pack of the vehicle.

14. A vehicle comprising:
a battery pack;
a frame comprising a frame member arranged on a lateral side of the battery pack and between a front wheel and a rear wheel, wherein:
the frame member comprises a plurality of rectangular tubes;
each rectangular tube of the plurality of rectangular tubes has a same cross-sectional shape; and
the plurality of rectangular tubes are laser seam welded together to form a stack; and
a bottom bracket affixed to a bottom side of the stack and coupled to the battery pack.

15. The vehicle of claim 14, wherein:
the plurality of rectangular tubes comprises N tubes;
N is an even integer;
a first N/2-by-1 array is welded together;
a second N/2-by-1 array is welded together; and
the first and second N/2-by-1 arrays are welded and fastened to each other.

16. The vehicle of claim 14, wherein:
the frame further comprises a front frame and a rear frame;
the frame member further comprises a first bracket configured to affix a first longitudinal end of the stack to the front frame; and
the frame member further comprises a second bracket configured to affix a second longitudinal end of the stack, arranged opposite the first longitudinal end, to the rear frame.

17. The vehicle of claim 14, wherein the bottom bracket is further coupled to a body of the vehicle.

18. A method of making a frame rail for a vehicle, the method comprising:
arranging a plurality of rectangular tubes to form a stack, wherein the plurality of rectangular tubes each have a same cross-sectional shape;
laser seam welding the plurality of rectangular tubes together in the stack; and
affixing a bottom bracket to the stack, wherein the bottom bracket is configured to be coupled to a battery pack of the vehicle.

19. The method of claim 18, wherein the plurality of rectangular tubes comprises a first set and a second set of rectangular tubes, and wherein arranging the plurality of rectangular tubes further comprises:
arranging the first set in a first stack;
arranging the second set in a second stack; and
longitudinally offsetting the first stack and the second stack from each other to form the stack such that the first stack and the second stack longitudinally overlap each other except at opposite longitudinal ends of the stack.

20. The method of claim 19, further comprising fastening the first stack to the second stack at a plurality of locations arranged longitudinally along the first stack.
